(19) United States
(12) Patent Application Publication
(10) Pub. No.: US 2008/0097004 A1
(43) Pub. Date: Apr. 24, 2008

(54) Roofing membranes having improved resistance to deleterious solar radiation

(76) Inventors: Jeffrey W. Henegar, Westfield, IN (US); James A. Davis, Westfield, IN (US)

Correspondence Address: Chief Intellectual Property Counsel;Bridgestone Americas Holding, Inc., 1200 Firestone Parkway, Akron, OH, 44317-0001, US

(21) Appl. No.: 10/836,749

(22) Filed: Apr. 30, 2004

Related U.S. Application Data
(60) Provisional application No. 60/466,925, filed on May 1, 2003.

(51) Int. Cl. A01G 9/14

(52) U.S. Cl. 523/135; 524/442; 524/448

(57) ABSTRACT

A roofing membrane comprising a polymer and an infrared reflective compound.

This application gains benefit from U.S. Provisional Patent Application No. 60/466,925, filed on May 1, 2003.

### FIELD OF THE INVENTION

This invention is directed toward roofing membranes having increased resistance to deleterious solar radiation.

### BACKGROUND OF THE INVENTION

Steep-sloped roofs are relatively expensive to construct and therefore many commercial buildings employ flat or low-sloped roofs. These roofing systems include built-up roofs, modified bitumen roofs, and single-ply or membrane roofing systems.

Single-ply or membrane roofing systems conventionally include carbon black as a filler. The carbon black advantageously adds integrity and durability to the membranes that often cannot be achieved by employing other reinforcing fillers. For example, it is believed that the carbon black particles have surface activity and thereby interact with each other or the polymers to form a continuous network.

The black color, however, can also be disadvantageous because black pigments and fillers, such as carbon black, absorb a significant amount of ultraviolet (UV) and infrared (IR) radiation from the sun. The IR radiation is associated with heat that, when absorbed by the membrane, may make it more difficult to cool the building being covered by the membrane. Also, cites and metropolitan areas have recently been concerned with the increase in heat that can be attributed to IR radiation absorbed by buildings, roads, and the like.

Several solutions have been proposed to overcome the impact of deleterious solar radiation on roofing membranes. In one instance, ballast material is applied over a roofing membrane. Many ballasted roof systems utilize standard ballast rock, which reflects 12-20% of solar spectrum energy. Ballast rock preferably is sized to ASTM Standard No. 4 and uniformly distributed over a membrane in an amount of about 5 kg/m². Somewhat higher reflectives can be obtained by using natural quartzite rock.

Unfortunately, this solution has not proven to be entirely useful because the preferred ballast materials are not readily available in every geographic region and, especially due to the extreme weight associated with the ballast material, transportation costs can be high. Also, the amount of reflectance offered by ballast materials could be more desirable.

Other solutions that have been proposed include the manufacture of white membranes. In this solution, mineral fillers including titanium dioxide are employed in lieu of carbon black. While the solutions have proven somewhat useful, the integrity offered by most mineral fillers is not as superior as what is offered by carbon black. Moreover, the ability to employ mineral fillers and achieve results similar to those obtained when carbon black is used often requires the use of very expensive mineral fillers that have been chemically treated.

### SUMMARY OF THE INVENTION

In general the present invention provides a roofing membrane comprising a polymer and an infrared reflective compound.

The present invention also provides a roofing membrane comprising a polymeric sheet, where the polymeric sheet comprises a polymer and from about 2 to about 100 parts by weight infrared reflective material per 100 parts by weight polymer.

The present invention further provides a flat roof comprising a roof deck, and a membrane over said roof deck, where the membrane comprises a polymer and from about 2 to about 100 parts by weight infrared reflective filler per 100 parts by weight polymer.

### DETAILED DESCRIPTION OF ILLUSTRATIVE EMBODIMENTS

Roofing membranes according to the present invention include infrared reflective compounds.

Roofing membranes include those typically employed on flat or low-slope roof systems. These membranes include those fabricated from compositions comprising ethylene-propylene-diene rubber (EPDM), thermoplastic olefins (TPO), thermoplastic vulcanizates (TPV), and polyvinyl chloride (PVC).

Useful EPDM membranes include those that are conventional and commercially available in the art. For example, EPDM membranes are commercially available under the tradename RUBBERGARD from the Firestone Building Products Company (Carmel, Ind.). Also, EPDM roofing membranes are disclosed in numerous United States patents including U.S. Pat. Nos. 3,280,082, 4,732,925, 4,810,565, 5,162,436, 5,286,798, 5,370,755, 5,242,970, 5,512,118, 2,260,111, 5,256,228, 5,582,890, 5,204,148, 5,389,715, 5,854,327, 5,054,327, and 5,700,538, which are incorporated herein by reference. Useful thermoplastic olefin membranes are available under the tradename ULTRAPLY™ TPO, and useful polyvinyl chloride membranes are available under the tradename ULTRAPLY™ PVC.

The EPDM membranes comprise EPDM or EPM. EPDM refers to terpolymers of ethylene, propylene, and diene monomer as defined in ASTM-D-1418-85. EPM refers to copolymers that contain from about 55 to about 70 weight percent ethylene with the balance being propylene as defined in ASTM-D-1418-85. EPDM membranes are preferably cured by using a curative in the formulation. Typically, the curatives are used in conjunction with various accelerators, the combination of which is often referred to as a cure package. Preferably, the cure package will include from about 1.5 to about 10 parts by weight per 100 parts by weight EPDM of a sulfur cure package that includes one organic vulcanizing accelerator.

EPDM membranes may also include extender oils, processing aids such as various metal salts of stearic acid, sodium dodecyl sulfate as well as tackifying resins, plasticizers, antioxidants, antiozonants, waxes, cure accelerators, zinc oxide, stearic acid, UV stabilizers, and the like.

The infrared reflective materials employed in the present invention, which may also be referred to as infrared reflective fillers or pigments, include those substances or compounds that reflect solar radiation in the infrared spectrum. Preferably, these materials will have increased reflectivity in the infrared region over that in the visible light region (i.e., they provide greater reflectivity in the infrared region than in the visible region). Some especially preferred materials will also have increased reflectivity in the ultraviolet region over that in the visible light region. Preferably, these materials will absorb a significant amount of solar energy within the visible light spectrum and thereby provide a dark color such as a green, brown, blue, or black color.

Infrared reflective materials are known and commercially available. For example, black pigments that reflect infrared solar radiation include those available from Degussa Metal Catalysts Cerdec Corporation. These include those available under the tradenames Eclipse™ Black 01201, Eclipse™ Black 10202, Eclipse™ Black 10203, and Eclipse™ Black 10204. Others include those under the tradename Cool Colors™, which are available from the Ferro Corporation of Cleveland, Ohio.

One useful infrared reflective material includes solid solutions including corundum-hematite crystalline structures. These solid solutions are disclosed in U.S. Pat. Nos. 6,454,848, 6,487,830, and U.S. Patent Application Publication No. US2004/0009319 A1, which are incorporated herein by reference.

The roofing membranes of the present invention preferably include from about 2 to about 100 parts by weight, more preferably from about 3 to about 95 parts by weight, more preferably form about 5 to about 90 parts by weight, even more preferably from about 10 to about 95 parts by weight, still more preferably from about 25 to about 65 parts by weight, and even more preferably form about 30 to about 50 parts by weight infrared reflective material per 100 parts by weight polymer.

The membranes of the present invention can be fabricated by employing standard techniques employed in the industry. The infrared reflective materials can be added to those formulations used in the membrane fabrication processes. Preferably, especially in the case of EPDM membranes, the infrared reflective material is added during the rubber compounding or mixing stage, which may employ standard Banbury or similar mixing equipment.

The membranes of this invention are incorporated into standard commercial roof systems. These roof systems generally include a roof deck, which is typically the structural supporting surface of a building extending between surrounding exterior walls of the building. The roof deck may be constructed from plywood, metal decking, concrete or any other suitable material. Depending upon the construction, the roof deck may extend over the surrounding exterior walls or the roof deck may stop short of the exterior walls, thereby forming a parapet wall, i.e., a low retaining wall at the edge of the roof deck. If desired, the roofing system may also include an insulation barrier formed from polyisocyanurate or any other suitable material applied over the roof deck.

Various modifications and alterations that do not depart from the scope and spirit of this invention will become apparent to those skilled in the art. This invention is not to be duly limited to the illustrative embodiments set forth herein.

1. A roofing membrane comprising:
a polymer; and
an infrared reflective compound, wherein the infrared reflective compound has greater reflectivity in the infrared region than in the visible light region.

2. The roofing membrane of claim 1, where the polymer comprise EPDM.

3. The roofing membrane of claim 1, where the polymer comprise TPO.

4. The roofing membrane of claim 1, where the polymer comprise PVC.

5. The roofing membrane of claim 1, where the membranes includes from about 2 to about 100 parts by weight infrared reflective compound.

6. The roofing membrane of claim 1, where the membranes includes from about 3 to about 95 parts by weight infrared reflective compound.

7. (canceled)

8. The roofing membrane of claim 1, where the infrared reflective compound has greater reflectivity in the ultraviolet region than in the visible light region.

9. The roofing membrane of claim 1, where the infrared reflective compound absorbs significant solar energy in the visible region so as to produce a dark color.

10. The roofing membrane of claim 1, where the infrared reflective material includes corundum-hematite crystalline structures.

11. A roofing membrane comprising:
a polymeric sheet, where the polymeric sheet comprises a polymer and from about 2 to about 100 parts by weight of an infrared reflective compound per 100 parts by weight polymer, wherein the infrared reflective compound has greater reflectivity in the infrared region than in the visible light region.

12. The roofing membrane of claim 11, where the polymeric sheet comprises EPDM.

13. (canceled)

14. The roofing membrane of claim 11, where the infrared reflective compound has greater reflectivity in the ultraviolet region than in the visible light region.

15. The roofing membrane of claim 11, where the infrared reflective compound absorbs significant solar energy in the visible region so as to produce a dark color.

16. A flat roof comprising:
a roof deck; and
a membrane over said roof deck, where the membrane comprises a polymer and from about 2 to about 100 parts by weight of an infrared reflective compound per 100 parts by weight polymer, wherein the infrared reflective compound has greater reflectivity in the infrared region than in the visible light region.

17. The flat roof of claim 16, where the polymer comprise EPDM.

18. (canceled)

19. The flat roof of claim 16, where the infrared reflective compound has greater reflectivity in the ultraviolet region than in the visible light region.

20. The flat roof of claim 16, where the infrared reflective compound absorbs significant solar energy in the visible region so as to produce a dark color.

21. A roofing membrane comprising:
a polymer;
carbon black; and
an infrared reflective compound, wherein the infrared reflective compound has greater reflectivity in the infrared region than in the visible light region.
